(19) United States
(12) Patent Application Publication
(10) Pub. No.: US 2002/0016199 A1
(43) Pub. Date: Feb. 7, 2002

(54) Homepage access method using lottery-numbered-email

(76) Inventor: Kenkou Yamaura, Komagane-City (JP)

Correspondence Address: VENABLE, BAETJER, HOWARD & CIVILETTI, LLP, P.O. Box 34385, Washington, DC, 20043-9998, US

(21) Appl. No.: 09/910,768

(22) Filed: Jul. 24, 2001

(30) Foreign Application Priority Data
Jul. 25, 2000 (JP) 2000-223461

(51) Int. Cl. G06F 17/00

(52) U.S. Cl. 463/17

(57) ABSTRACT

A homepage access method using lottery numbered e-mails for network users only, which allows a great improvement in the number of accesses to a homepage with extremely low costs. Terminal devices 1a to 1d such as personal computers, mobile telephones, and so on access a server 10 having a homepage for sending/receiving e-mails over a network 11. Then, when the terminal devices 1a to 1d start up a mailer on the homepage in order to send an e-mail, a mail sending portion 13 writes a lottery number and an address of the homepage at the end of the e-mail and then sends the mail to a mail receiver. The receiver accesses the homepage in order to check whether the lottery number written in the e-mail wins or not. This increases the number of accesses for the homepage.

### BACKGROUND OF THE INVENTION

1. Field of the Invention

The present invention relates to a homepage access method using lottery-numbered e-mails, which allows an increase in the number of accesses to a homepage.

2. Description of the Related Art

It is very important issue in E-business of how the number of accesses to a homepage by Internet users can be increased.

In conventional homepages, a method for increasing the number of accesses mainly includes linking to other popular homepages or increasing the recognition of the homepage by performing advertising activities in other media such as TV and direct mail.

However, linking by placing banner advertisements on popular sites and/or using other media generally causes higher advertisement costs. Further, since such advertisements are also supplied to people who do not use the Internet, it is not efficient.

### SUMMARY OF THE INVENTION

The present invention was made in view of the above-described problems. Accordingly, it is an object of the present invention to provide a homepage access method by using lottery-numbered e-mails for Internet users only, which allows a great improvement in the number of accesses to a homepage with extremely low costs.

According to an aspect of the present invention, a homepage access method using lottery numbered e-mails is provided for accessing a server device having a homepage for providing a mail sending/receiving service to terminal devices such as personal computers and mobile phones over a network. When the terminal device accesses the homepage and starts up a mailer program on the homepage in order to send an e-mail, the method comprises the steps of the server device writing in a lottery number and an address of the homepage at the end of an e-mail and attaching, to the e-mail, a message indicating that winning lottery numbers will be announced on the homepage.

In this case, the method may further comprise the steps of the server device displaying a winner registration screen in response to a user registration request from the terminal device, instructing the input of required information, storing the required information in a user registration file in response to the user input in accordance with the instructions, rewriting the sending mail server (SMTP) setting, and assigning and informing of a nickname to the user requesting the registration.

Preferably, the server device has an original mailer set for accessing the homepage for sending/receiving mail. In this case, the method may further comprise the steps of allowing the terminal device to download the original mailer, and causing the terminal device to access the homepage in order to send an e-mail by using the downloaded original mailer.

According to the above-described construction, the number of accesses to a homepage can be increased since a lottery number and an address of the homepage are displayed at the end of a received e-mail and the mail receiver accesses the homepage in order to check the result of the lottery. By repeating this, the user informs the presence of the homepage to other users as a result, which further increases the number of accesses to the homepage.

### BRIEF DESCRIPTION OF THE DRAWINGS

FIG. 1 is a schematic diagram showing an embodiment of a homepage access method using lottery-numbered e-mails according to the present invention;

FIG. 2 is a flowchart for explaining the operations of respective circuits of an e-mail sending portion, of a winner-registration portion, and of a winning number nickname display portion in a server;

FIG. 3 is a flowchart of the operations of respective circuits of a user registration portion and of a mailer download portion in the server;

FIG. 4 is a flowchart for describing an access form of according to the present invention;

FIG. 5 is a flowchart for explaining the operations for sending e-mail and receiving gifts;

FIG. 6 is a diagram for describing the construction of a main menu screen according to the present invention;

FIG. 7 is a diagram for showing an example of SMTP-rewriting in a sending mail server; and

FIG. 8 is a diagram showing an example of sending e-mail.

### DESCRIPTION OF THE PREFERRED EMBODIMENTS

An embodiment of the present invention will be described in detail below with reference to drawings.

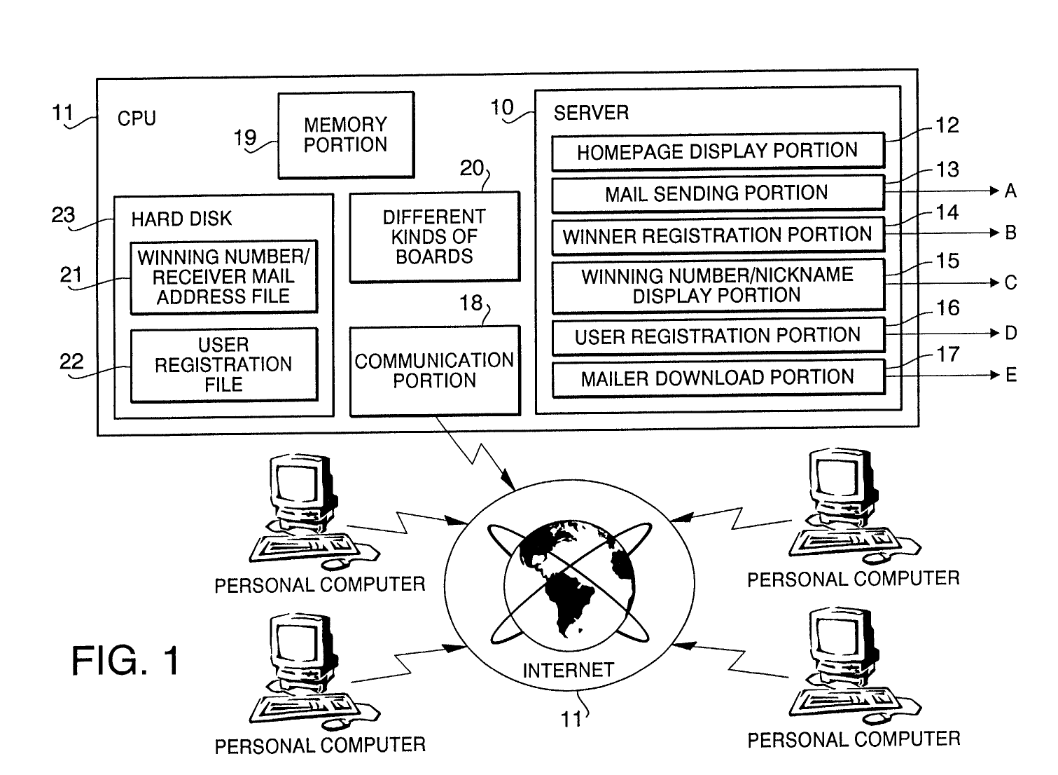

FIG. 1 is a schematic diagram showing an embodiment of a homepage access method using lottery-numbered e-mails according to the present invention.

Personal computers (terminal devices) 1a to 1d can access the Internet 11. Mobile phones such as personal handy phones and cellular phones may be used as the terminal device. The Internet 11 and the terminal devices 1a to 1d are connected through a dial-up by using telephone lines, leased lines, and so on.

A homepage provided by a lottery-number mail server 10 is connected to the Internet 11, and can even be used as a mail server for any terminal device.

The server 10 includes a CPU 11, a memory portion 19 including ROM and RAM, a hard disk 23 storing winning numbers/receiver mail address file 21, and a user registration file 22, boards 20 for realizing predetermined functions on the server, and a communication portion 18 having modem and terminal adapter functions.

The CPU 11 implements, by using a control program, each function of a homepage display portion 12, a mail sending portion 13, a winner registration portion 14, a winning number/nickname display portion 15, a user registration portion 16, and a mailer download portion 17.

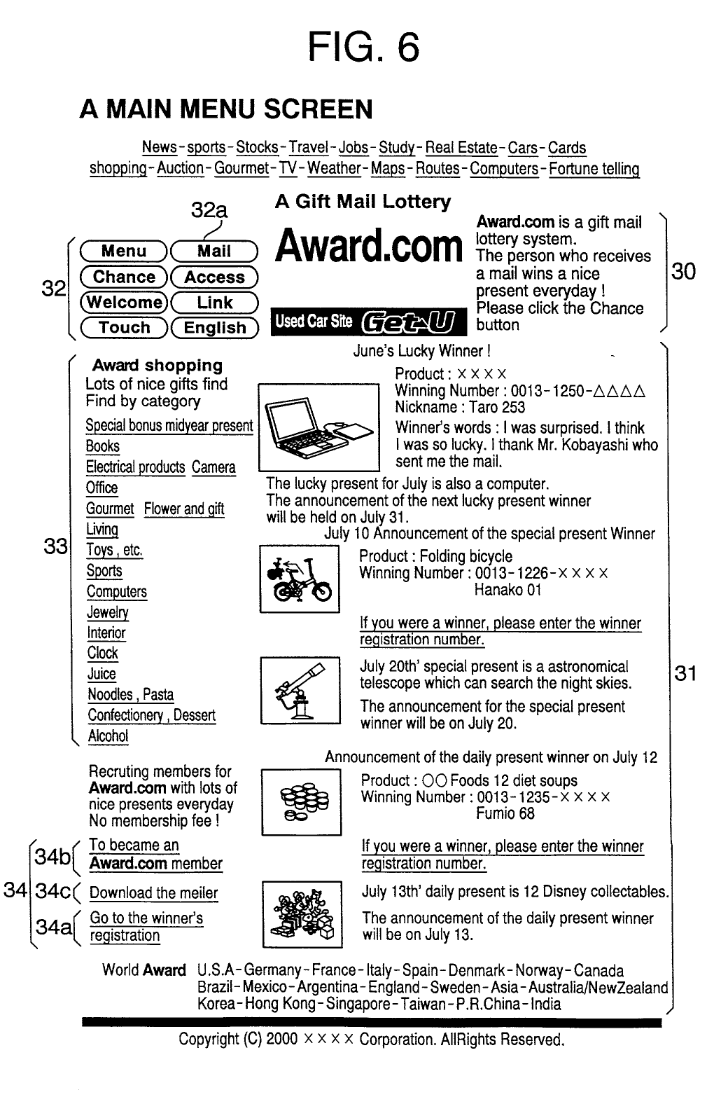

The homepage display portion 12 displays a screen as shown in FIG. 6, for example, when the homepage is accessed from a terminal device.

This example is an example of a main menu screen. In this screen, when the homepage is used to send/receive an e-mail, a lottery number is added to the e-mail. A message portion 30 indicating that there is a chance for winning a present is displayed to the person who received the e-mail. Further, a message portion 31 including a winner's winning number and nickname for each predetermined period is displayed. Furthermore, a button 32 for linking to each function, such as a mail button, an access button 33 for linking to a shopping guide, and an access button 34 for linking to member registration screens, original mailer download, and winner registration are provided.

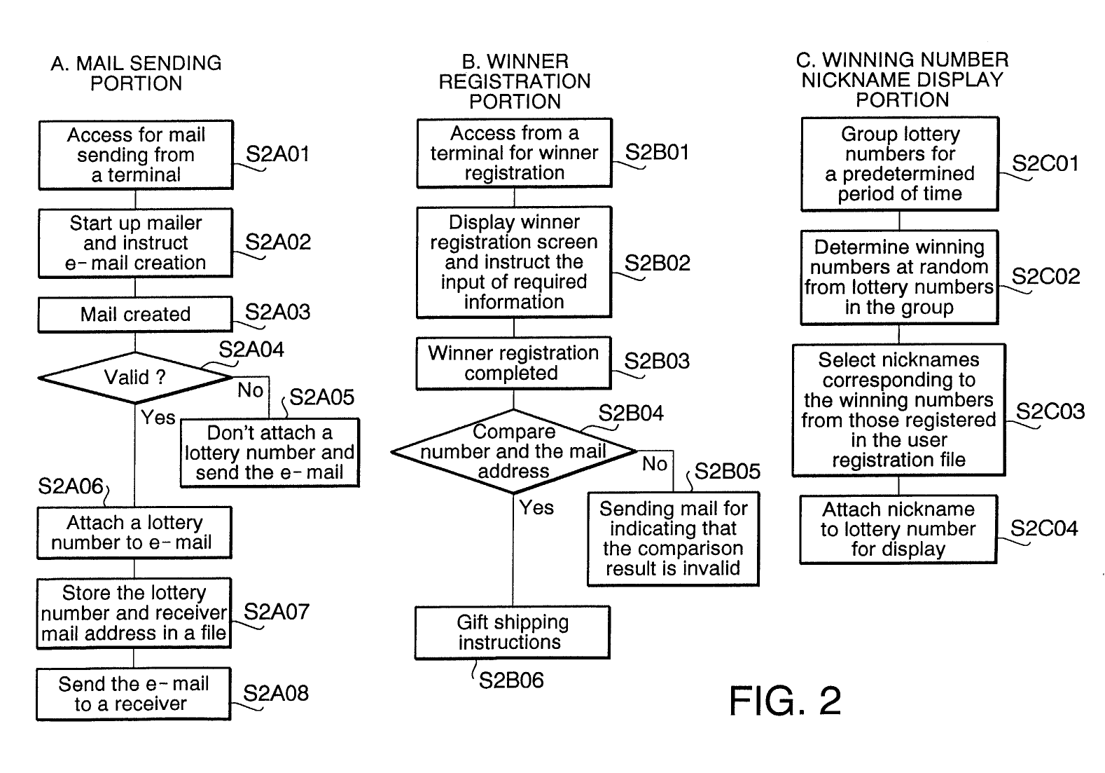

FIG. 2 is a flowchart for describing the operations of respective circuits of a mail sending portion, a winner registration portion and a winning number nickname display portion in the server.

When a user accesses the homepage and clicks the “mail sending button 32a” on the main menu screen (see FIG. 6) in order to start up the mailer, the mail sending portion 13 detects the access for sending mail from a terminal device (where “S” refers to step S2A01). Then, the mailer is started up and an e-mail to be input by the user is created (S2A02). When the mail is completed, validity of the e-mail is determined (S2A03, S2A04). The validity is checked so that a sender of the sent mail and the mail address of a receiver are not the same (that is, the mail is not sent to the sender himself/herself), and that the receiver is not on a mailing list.

If invalid, the mail is sent without any lottery number (S2A05). If valid, a lottery number and a homepage address are attached to the end of the mail (S2A06). Then, the lottery number and the receiver's mail address are stored in the winning number/address file 21, and the lottery-numbered mail is sent to the receiver via the Internet (S2A07, S2A08).

Notably, when an e-mail is created on the original mailer and without attaching any lottery number in the e-mail sending portion in the server and the sending instruction is given, the data is exchanged with the server before sending mail. Then, a lottery number is attached to the e-mail on the terminal and the lottery numbered e-mail is sent via a general SMTP server.

The determination of winning numbers and the nickname display will be performed as follows:

The server 10 performs processing for determining winning numbers at random from lottery numbers of mail sent within a predetermined period of time, which are stored in the winning number/receiver mail address file 21 (S2C01, S2C02). Then, in order to display winning numbers only, the user registration file 22 is searched for mail addresses corresponding to the winning numbers determined at the above-described steps (S2C01 and S2C02), and nicknames of the winners are extracted (S2C03) because checking winning numbers may be inconvenient for users.

The result above is displayed on the “winning number/nickname display” portion 31 on the main menu screen (S2C04). Here, when the winner has not registered as a user, his/her nickname is not displayed.

The winner registration is performed by the winner registration portion 14. When the mail receiver identifies his/her winning on the main menu screen in FIG. 6, and when he/she clicks a “To Winner Registration Screen” button 34a of the access button 34 at the lower left (S2B01), the winner registration screen is displayed, where instructions are given for inputting his/her shipping address, name, and e-mail address (S2B02). Once the input is completed in accordance with the instructions (S2B03), the winner registration portion 14 compares the winner number and the e-mail address (S2B04). If the result of the comparison is “invalid”, an e-mail indicating that it is invalid is sent (S2B05). If winning the prize is confirmed, a gift sending instruction is performed via the Internet 11 (S2B06).

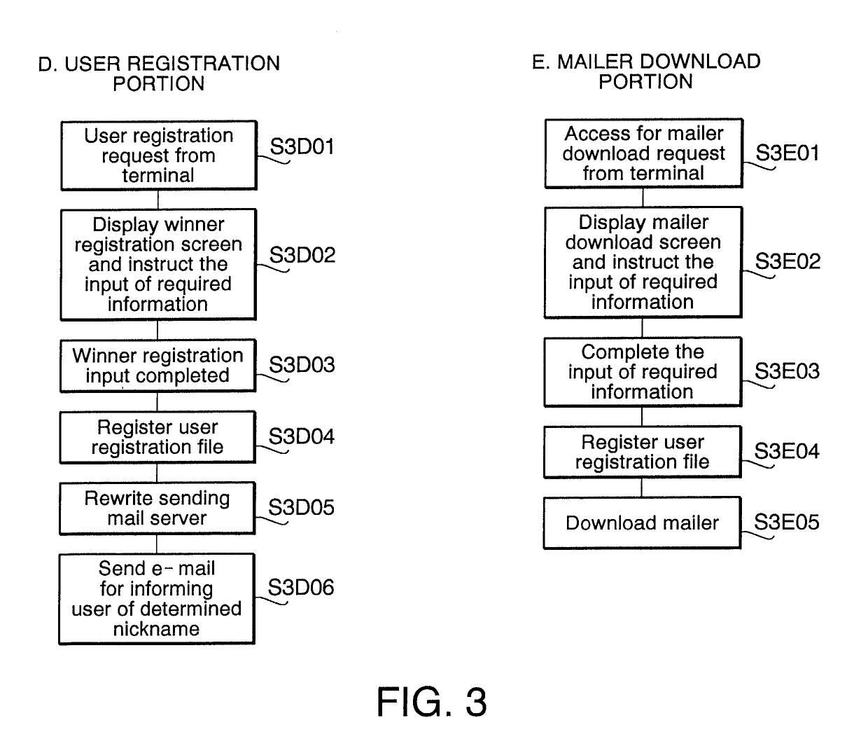

FIG. 3 is a flowchart for explaining the operations of respective circuits of the user registration portion and the mailer download portion in the server.

When the user registration is performed, a “user registration” button (to become (tentative) Award member) 34b of the access button 34 on the main menu screen in FIG. 6 is clicked (S3B01). The user registration portion 16 opens the user registration screen and instructs the input of user's e-mail address and nickname to be used for display when winning (S3B02). Once the input is completed in accordance with the instructions (S3B03), the input is stored in the user registration file 22 (S3B04). Then, the setting (SMTP) in the sending mail server in the user's terminal device is rewritten as the mail server of the server 10 (S3B05).

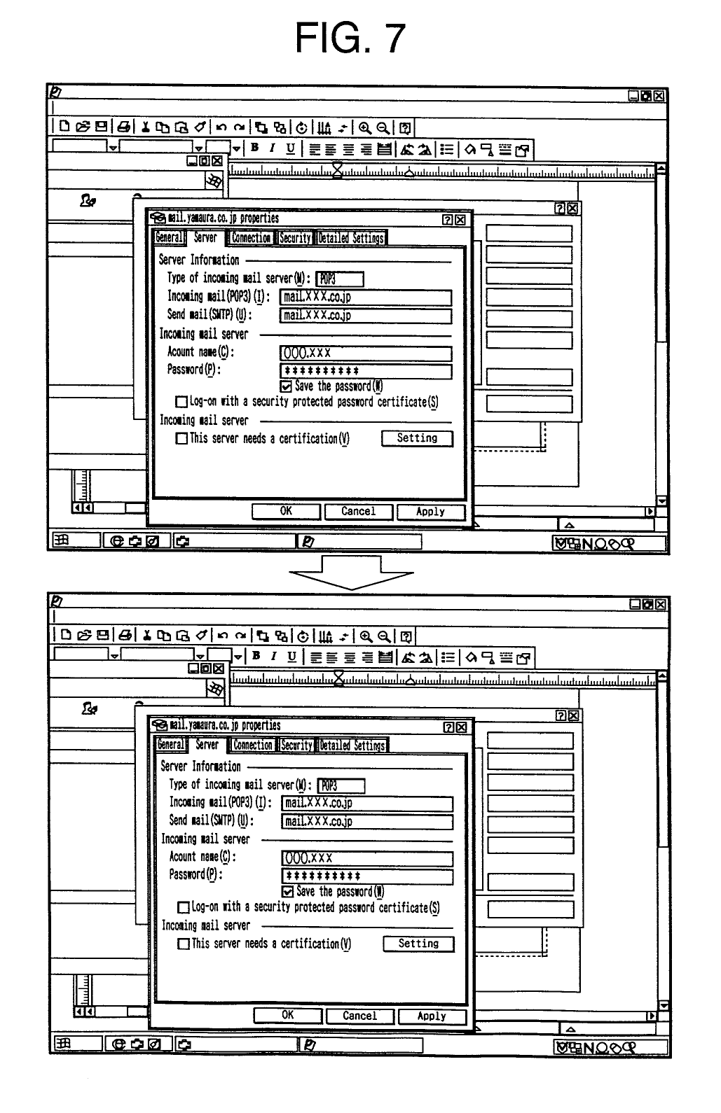

FIG. 7 shows an example where the SMTP of the sending mail server is rewritten. In this example, the SMTP “mail.XXXX.co.jp” is rewritten to “mail.Award.com”.

After that, an e-mail informing the user of the determined nickname is sent (S3B06).

If participation in this system is desired, the original mailer can be downloaded. An “Original Mailer Download” button 34c on the main menu screen in FIG. 6 is clicked (S3E01). The mailer download portion 17 displays a mailer download screen and then instructs an input of required information (S3E02). Once the input is completed in accordance with the instructions (S3E03), the required information is registered in the user registration file, and mailer downloading is started (S3E04, S3E05). Then, the original mailer is downloaded to the user's terminal device.

It should be noted that mail sending agent software can be used for sending mail without using the original mailer. The mail sending agent software incorporates a mail created by a popular mailer, sends it to a given server, attaches a lottery number thereto on the given server, and then transfers it from the server to a receiver specified by the sender.

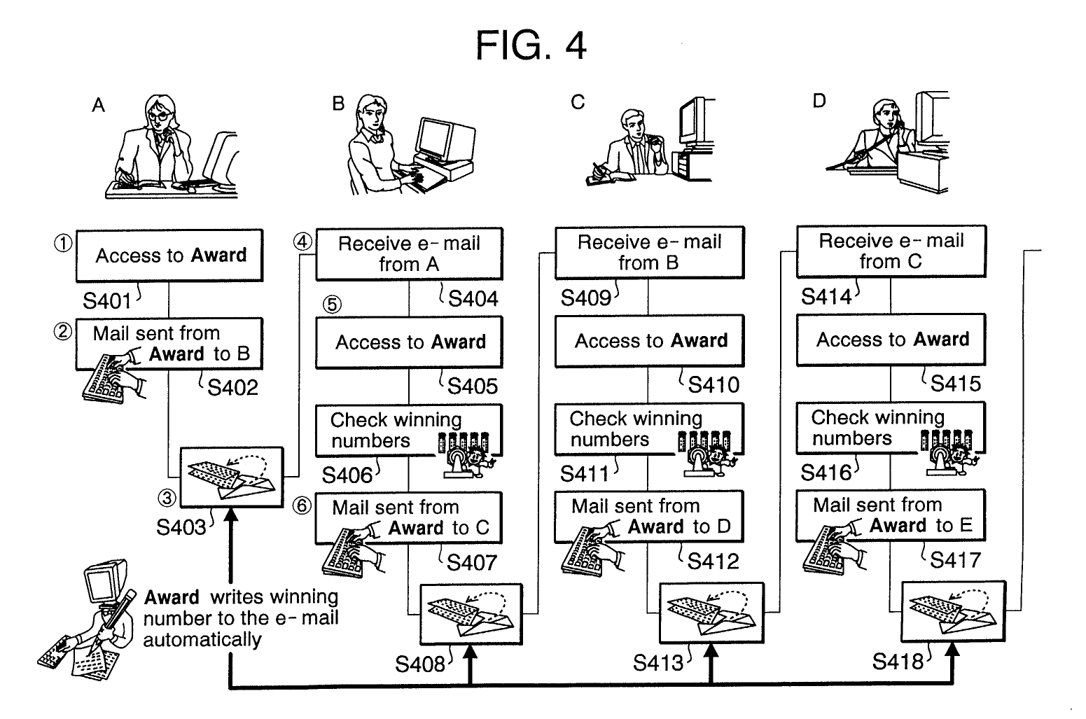

FIG. 4 is a flowchart for explaining an access form according to the present invention.

FIG. 4 shows a case where mail is sent from A to B, from B to C, and from C to D. When A sends mail, a lottery number is inserted into the mail automatically in S403. When B receives the mail from A, he/she accesses to AWARD in order to check the lottery number. Then, when the mail is sent to C, a lottery number is also inserted into the mail automatically in S408. When C receives the mail from B, he/she accesses AWARD in order to check the lottery number. Then, when the mail is sent to D, a lottery number is also inserted into the mail automatically in S413. In this way, the number of accesses to AWARD from the terminal device can be increased.

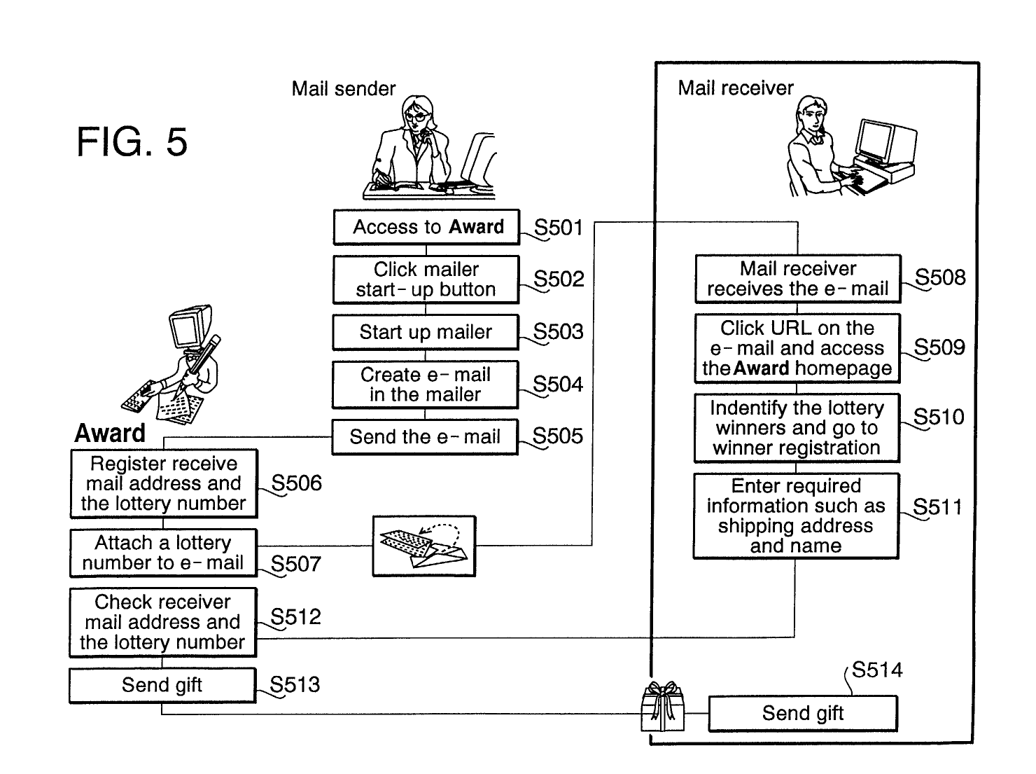

Next, processes from sending mail to receiving gifts by a mail receiver will be described with reference to the flowchart in FIG. 5.

A mail sender accesses AWARD's homepage. When he/she clicks the “mail sending button” on the homepage, the mailer is started up. The sender creates and sends a mail by using the mailer (S501 to S505).

The server registers the mail receiver's e-mail address and lottery number automatically to the mail sent by the sender, and attaches the lottery number to the end of the mail (S506, S507). Further, information about the lottery event and the homepage address are attached.

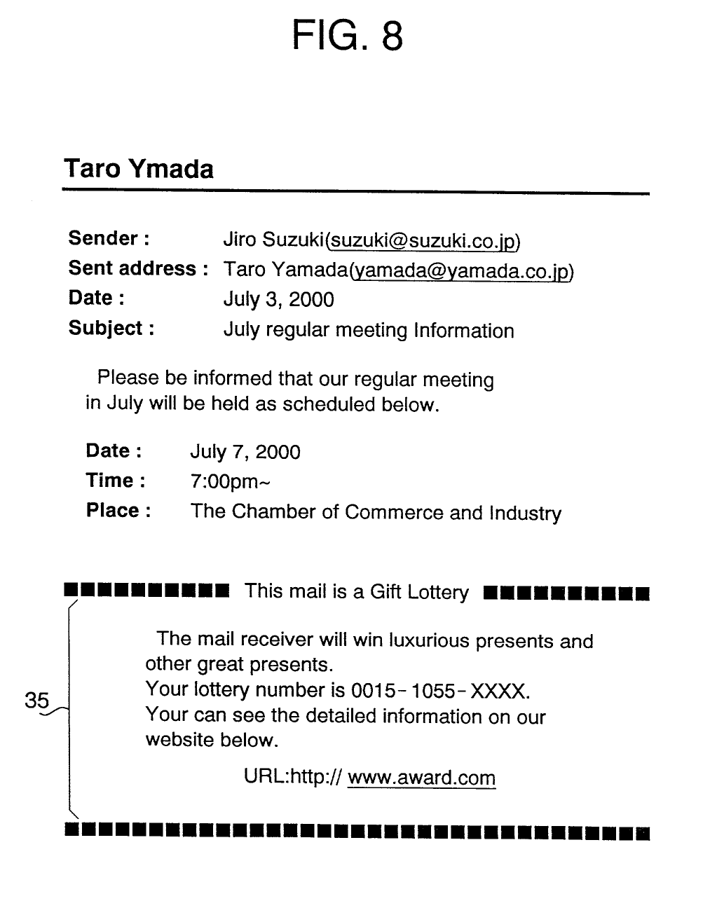

FIG. 8 shows an example to be attached to the mail.

A message portion 35 is inserted at the end of the mail, where the prize information, a lottery number, and the homepage address are written.

When receiving the mail, the mail receiver accesses to the Award homepage in order to check the prize winners as a result of reading the above-described description (S508, S509). If he/she identifies that his/her lottery number is a winning number on the homepage, he/she clicks the winner registration button and inputs required information including his/her address, name and so on (S510, S511).

The server 10 compares the winner registration content with the mail address and the lottery number of the receiver registered in the server at the time when the mail was sent in order to identify that he/she is the person himself/herself (S512). If the identification is valid, the homepage manager ships the gift to the winner (S513). Thus, the winner can receive the gift (S514).

As described above, in the present invention, the number of accesses to a homepage can be increased since a lottery number and an address of the homepage are displayed at the end of a received e-mail and the mail receiver accesses the homepage in order to check the result of the lottery. By repeating this, the user informs the presence of the homepage to other users as a result, which further increases the number of accesses to the homepage.

What is claimed is:

1. A homepage access method using lottery numbered e-mails, said method being used for accessing a server device having a homepage for providing a mail sending/receiving service to terminal devices such as personal computers and mobile phones over a network, when said terminal device accesses said homepage and starts up a mailer on said homepage in order to send an e-mail, said method comprising the steps of:
writing, with said server device, in a lottery number and an address of said homepage at the end of an e-mail; and
attaching, with said server device, to said e-mail, information for indicating that winning lottery numbers will be announced on said homepage.

2. A homepage access method using lottery numbered e-mails, said method being used for accessing a server device having a homepage for providing a mail sending/receiving service to terminal devices such as personal computers and mobile phones over a network, when said terminal device creates an e-mail on a mailer and instructs the sending of said e-mail in order to access said homepage, said method comprising the steps of:
sending, with said server device, a lottery number and an address of said homepage to said terminal device;
attaching, with said server device, a lottery number to said e-mail on said terminal device;
sending, with said server device, said lottery numbered e-mail via a general SMTP server; and
attaching, with said server device, to said e-mail, information for indicating that winning lottery numbers will be announced on said homepage.

3. A homepage access method using lottery numbered e-mails according to claim 1, further comprising the steps of:
displaying, with said server device, a winner registration screen in response to a user registration request from said terminal device;
instructing, with said server device, an input of required information;
storing, with said server device, said required information in a user registration file in response to the user input in accordance with said instruction;
rewriting, with said server device, the sending mail server (SMTP) setting; and
assigning and informing, with said server device, of a nickname to said user requesting said registration.

4. A homepage access method using lottery numbered e-mails according to claim 1, wherein said server device has an original mailer set for accessing said homepage for sending/receiving mail, further comprising the steps of:
allowing, with said server device, said terminal device to download said original mailer; and
causing, with said server device, said terminal device to access to said homepage in order to send an e-mail by using said downloaded original mailer.
